(19) United States
(12) Patent Application Publication
(10) Pub. No.: US 2018/0024968 A1
(43) Pub. Date: Jan. 25, 2018

(54) SYSTEM AND METHOD FOR DOMAIN ADAPTATION USING MARGINALIZED STACKED DENOISING AUTOENCODERS WITH DOMAIN PREDICTION REGULARIZATION

(71) Applicant: Xerox Corporation, Norwalk, CT (US)

(72) Inventors: Stéphane Clinchant, Grenoble (FR); Gabriela Csurka, Crolles (FR); Boris Chidlovskii, Meylan (FR)

(73) Assignee: Xerox Corporation, Norwalk, CT (US)

(21) Appl. No.: 15/216,805

(22) Filed: Jul. 22, 2016

(51) Int. Cl. G06F 17/14; G06N 7/00; G06N 99/00

(52) U.S. Cl. CPC G06F 17/14; G06N 99/005; G06N 7/005

(57) ABSTRACT

A method for domain adaptation of samples includes receiving training samples from a plurality of domains, the plurality of domains including at least one source domain and a target domain, each training sample including values for a set of features. A domain predictor is learned on at least some of the training samples from the plurality of domains and respective domain labels. Domain adaptation is performed on the training samples using marginalized denoising autoencoding. This generates a domain adaptation transform layer (or layers) that transforms the training samples to a common adapted feature space. The domain adaptation employs the domain predictor to bias the domain adaptation towards one of the plurality of domains. Domain adapted training samples and their class labels can be used to train a classifier for prediction of class labels for unlabeled target samples that have been domain adapted with the domain adaptation transform layer(s).

### BACKGROUND

The following relates to domain adaptation and finds particular application in connection with a system and method which combine denoising autoencoders with domain prediction regularization for domain adaptation tasks.

Domain adaptation leverages labeled data in one or more related source domains to learn a classifier for unlabeled data in a target domain. One illustrative task that can benefit from domain adaptation is customer feedback understanding across products and services. For example, it may be useful to train a classifier on customer feedback on a range of tagged text-based documents (where “text-based” denotes the documents comprise sufficient text to make textual analysis useful) such as social media, news feeds, emails, chat and surveys, given a product or service. The trained classifier receives as input a feature vector representation of a document, for example, a “bag-of-words” feature vector, and the classifier output is, for example, a prediction of whether the customer was satisfied or not. In this task, the newly acquired unlabeled corpus containing reviews/surveys of another product or services is the “target domain,” and the previously available corpora are the “source domains.” Leveraging source domain data in training a classifier for the target domain is complicated by the possibility that the source corpora may be materially different from the target corpus, e.g,. using different vocabulary (in a statistical sense). Domain adaptation methods tend to exploit the correlation between the source and target domain adjusting the source classifier to perform better on the target reducing the annotation burden for the new product/service.

Another illustrative task that can benefit from domain adaptation is object recognition performed on images acquired by cameras at different locations or obtained under different lighting conditions. For example, a new traffic surveillance camera may be installed at a traffic intersection, which is to identify vehicles running a traffic light governing the intersection. The object recognition task is thus to identify the combination of a red light and a vehicle imaged illegally driving through this red light. In training an image classifier to perform this task, substantial information may be available in the form of labeled images acquired by red light enforcement cameras previously installed at other traffic intersections. In this case, images acquired by the newly installed camera are the “target domain” and images acquired by red light enforcement cameras previously installed at other traffic intersections are the “source domains”. Again, leveraging source domain data in training a classifier for the target domain is complicated by the possibility that the source corpora may be materially different from the target corpus, e.g. having different backgrounds, camera-to-intersection distances, poses, view angles, lighting conditions, and the like.

These are merely illustrative tasks. More generally, any machine learning task that seeks to learn a classifier for a target domain having limited or no labeled training samples, but for which one or more similar source domains exist with labeled training samples, can benefit from performing domain adaptation to leverage these source domain(s) data in learning the classifier for the target domain.

Stacked marginalized denoising autoencoders (mSDAs) are a known approach for performing domain adaptation between a source domain and a target domain. See Chen et al., “Marginalized denoising autoencoders for domain adaptation”, ICML (2014); Xu et al., “From sBoW to dCoT marginalized encoders for text representation,” CIKM, pp. 1879-84 (ACM, 2012). Each iteration of the mSDA corrupts features of the feature vectors representing the training samples to produce a domain adaptation layer, and repeated iterations thereby generate a stack of domain adaptation transform layers operative to transform the source and target domains to a common adapted domain. Noise marginalization in the mSDA domain adaptation enables a closed form solution to be obtained and can considerably reduce the training time.

Deep Learning has also been proposed as a generic solution to domain adaptation and transfer learning problems (X. Glorot, et al., “Domain adaptation for large-scale sentiment classification: A deep learning approach,” ICML, pp. 513-520, 2011; S. Chopra, et al., “DLID: Deep learning for domain adaptation by interpolating between domains,” ICML, 2(6), 2013; M. Long, et al., “Learning transferable features with deep adaptation networks,” ICML, pp. 97-105, 2015). In one approach, a deep neural architecture embeds a domain prediction tasks by incorporating a gradient reversal layer (Yaroslav Ganin, et al., “Unsupervised domain adaptation by backpropagation,” Proc. 32nd Int'l Conf. on Machine Learning (ICML 2015), pp. 1180-1189, 2015; Yaroslav Ganin, et al., “Domain-adversarial training of neural networks,” arXiv:1505.07818, 2015, hereinafter, Ganin 2015). While such solutions can perform relatively well in some tasks, the refinement may require a significant amount of new labeled data.

### INCORPORATION BY REFERENCE

The following references, the disclosures of which are incorporated herein in their entireties by reference, are mentioned:

U.S. application Ser. No. 15/013,273, filed Feb. 2, 2016, entitled DOMAIN ADAPTATION BY MULTI-NOISING STACKED MARGINALIZED DENOISING ENCODERS, by Boris Chidlovskii, et al.

U.S. application Ser. No. 14/950,544, filed Nov. 24, 2015, entitled ADAPTED DOMAIN SPECIFIC CLASS MEANS CLASSIFIER, by Gabriela Csurka, et al.

U.S. application Ser. No. 15/013,401, filed Feb. 2, 2016, entitled ADAPTING MULTIPLE SOURCE CLASSIFIERS IN A TARGET DOMAIN, by Boris Chidlovskii, et al.

### BRIEF DESCRIPTION

In accordance with one aspect of the exemplary embodiment, a method for domain adaptation of samples includes receiving training samples from a plurality of domains, the plurality of domains including at least one source domain and a target domain. Each training sample includes values for a set of features. A domain predictor is learned on at least some of the training samples from the plurality of domains and respective domain labels. Domain adaptation is performed using marginalized denoising autoencoding operating on the training samples to generate at least one domain adaptation transform layer operative to transform the training samples to a common adapted feature space. The domain adaptation employs the domain predictor to bias the domain adaptation of the source domain training samples towards one of the plurality of domains. The at least one domain adaptation transform layer, and/or information generated therefrom is output.

One or more of the steps of the method may be implemented by a processor.

In accordance with another aspect of the exemplary embodiment, a system for domain adaptation includes a domain predictor for predicting a domain of a plurality of domains for a sample, the sample including values for a set of features, the plurality of domains including at least one source domain and a target domain. A mapping component receives a set of training samples from the plurality of domains. Each training sample includes values for the set of features. The training samples from each of the at least one source domain may each be labeled with labels of a set of class labels. The mapping component performs domain adaptation using marginalized denoising autoencoding on the set of training samples to generate at least one domain adaptation transform layer operative to transform the training samples to a common adapted feature space. The domain adaptation incorporates the domain predictor to bias the domain adaptation of the source domain training samples towards one of the plurality of domains. A processor implements the mapping component.

In accordance with another aspect of the exemplary embodiment, a classification method includes receiving an input sample from a source domain, the input sample including values for a set of features. The input sample is classified with a classifier that has been trained on a set of domain adapted training samples. The domain adapted training samples each include values for the set of features. The domain adapted training samples have been generated from a set of training samples from a plurality of domains including a source domain and a target domain. The training samples have been transformed to an adapted feature space using a marginalized denoising autoencoding layer incorporating a domain predictor, whereby the transformation of source domain target samples is biased towards the target domain such that the domain adapted source domain target samples are more likely to be predicted to be target domain samples by the domain predictor. A class label prediction for the input sample is output, based on the classification.

One or more of the steps of the method may be implemented by a processor.

### BRIEF DESCRIPTION OF THE DRAWINGS

FIG. 1 is a functional block diagram of a domain adaptation system for classification of target samples, such as images or text documents, in accordance with one aspect of the exemplary embodiment;

FIG. 2 is a flow chart illustrating a domain-adapted classification method in accordance with another aspect of the exemplary embodiment;

FIG. 3 illustrates an sMDA component in accordance with one aspect of the exemplary embodiment;

FIG. 4 is a flow chart illustrating a part of the domain-adapted classification method of FIG. 2;

FIG. 5 is a plot which shows a relationship between expansion weight and log Document Frequency;

FIG. 6 is a plot which shows log Document Frequency vs. log Expansion Weight for a Baseline mSDA method; and

FIG. 7 shows log Expansion Weight vs. log Document Frequency for a Target Regularized mSDA method.

### DETAILED DESCRIPTION

Aspects of the exemplary embodiment relate to a system and method for generating a mapping for generating adapted training samples which can be used for adapting a classifier to a target domain. The exemplary system and method use marginalized stacked denoising autoencoders, with a domain prediction regularization for the adaptation. The exemplary method does not seek domain invariant features but rather an asymmetric transformation of the source collection toward the target one so that the distribution of features is closer to the target collection.

In one embodiment, the computer-implemented system and method are used for learning a classifier model suited to predicting class labels for target samples from a target domain. The classifier model is learned using representations of source samples from one or more source domains that are adapted to the target domain by embedding the source representations in an embedding space in which they are more likely to be classed as target samples from the target domain than the original representations. In one exemplary embodiment, target and source samples are used to learn an embedding function which embeds source samples in the embedding space. The source and target representations are feature-based vectorial representations of objects. Embedded source representations and associated class labels can be used to adapt a classifier model for use in the target domain. Aspects also relate to a system and method for classifying samples in the target domain with the learned classifier model.

The domain adaptation enables transferring a classification model from a source domain to a different but related target domain. In the exemplary method, marginalized stacked denoising autoencoders (mSDA) with a domain prediction regularization are used to adapt the features of the source domain representations to the target domain. An evaluation of the method on publically available text collections shows that the method provides results that are at least comparable existing methods. Due to a closed form of the solution, this represents a considerable time saving with respect to the full deep network training time employed in other methods.

In one embodiment, the source and target samples are multidimensional features-based representations of images, such as photographic images or scanned images of documents. The features on which the multidimensional image representations are based can be extracted from patches of the images or extracted using a deep neural network. In another exemplary embodiment, the source and target samples are multidimensional features-based representations of text documents. In this case, at least some of the features are based on character or word occurrences in the text. However, the objects being represented are not limited to images and text documents, and the samples are not limited to any specific type of representation. The method finds application in a variety of data processing fields where the data is received in the form of multi-dimensional representations in a common feature space.

In the framework of marginalized denoising autoencoders, the denoising transformation and the domain prediction task can be jointly minimized. A closed solution to this optimization problem is described. An extension of the joint optimization to a semi-supervised setting is also described in which the solution does not have a closed form. The closed form can be faster than corrupting the samples and fine tuning with stochastic descent.

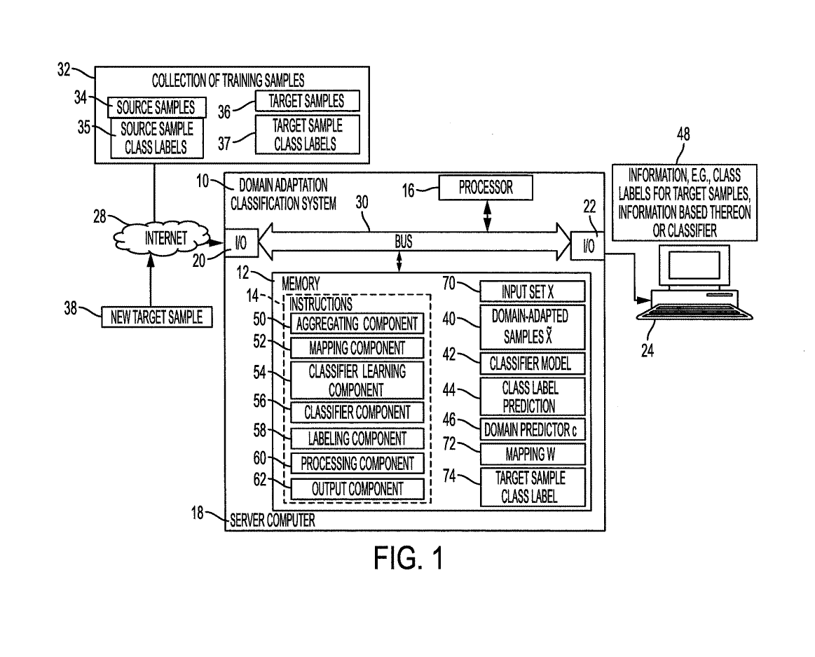

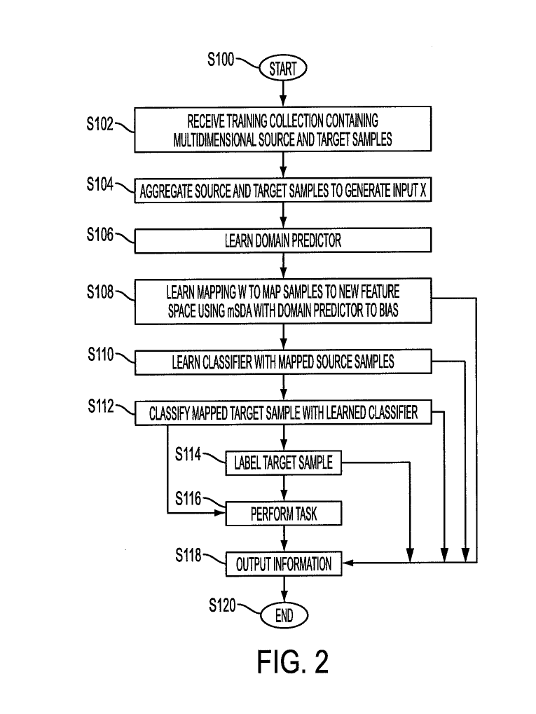

FIG. 1 illustrates a computer-implemented domain adaptation system 10 in accordance with one aspect of the exemplary embodiment. The system includes memory 12, which stores instructions 14 for performing the method described in FIG. 2 and a processor 16, in communication with the memory, for executing the instructions. The system may be hosted by one or more computing devices, such as the illustrated server computer 18 and may include one or more input/output devices 20, 22 for communicating with external devices, such as one or more remote customer computing devices 24, e.g., via a wired or wireless network, such as the Internet 28. Hardware components 12, 16, 20, 22 of the system 10 may communicate via data/control bus 30.

The domain adaptation system 10 has access to a collection 32 of training samples which includes a set of source samples 34 and their respective class labels 35, for at least one source domain, and a set of target samples 36 and optionally their respective class labels 37 for a target domain, different from the source domain. In one embodiment, at least a portion of the target samples 36 are labeled. The labeled source and target samples may be received by the system 10 from the same or different sources. For example, the target samples may be received from a customer seeking a classifier for use in the customer's target domain, while the source samples may have been generated previously for training a classifier for the source domain. As will be appreciated, source domains may serve as a target domain, and vice versa, in other cases. The interface 20 is configured for receiving the training samples 34, 36 and target samples 38 (or objects from which the training/target samples are generated) and may include a modem linked to a wired or wireless network, a portable memory receiving component, such as a USB port, disk drive, or the like.

The labeled source samples 34 are adapted, by the system, to form a corresponding output set 40 of domain-adapted samples, which may be used (together with any adapted target samples which have labels) to learn a classifier model 42 for the target domain. Given an input target sample 38 (which may be an unlabeled one of the set 36 or a new sample), the trained classifier model 42 outputs a classification value, such as a predicted class label 44 or predictions over a set of class labels. In the exemplary embodiment, the source samples 34 and target samples 36 (or a separate set of the source samples 34 and target samples 36) are used to learn a domain predictor 46 for predicting the domain from which a given sample is drawn. The domain predictor 46 helps to bias the domain-adaptation of the source samples 34 to produce adapted source samples that are more like the target samples 36 (i.e., which are more likely to be predicted as being target samples) than the original set of source samples 34.

The computer-implemented system 10 may include one or more computing devices 18, such as a PC, such as a desktop, a laptop, palmtop computer, portable digital assistant (PDA), a server computer, cellular telephone, tablet computer, pager, combination thereof, or other computing device capable of executing instructions for performing the exemplary method. For example, the class labeling may be performed on server computer 18 and the class label prediction 44, and/or other information 48 based thereon, is output to a linked client device 24, or added to a database (not shown), which may be accessible to the system 10 and/or client device 24, via wired or wireless links, such as the internet 28.

The exemplary instructions 14 include an aggregating component 50, a mapping component 52, a learning component 54, a classifier component 56, a labeling component 58, a processing component 60, and an output component 62.

The aggregating component 50 generates an input set 70 of training data by concatenating the source and target samples 34, 36.

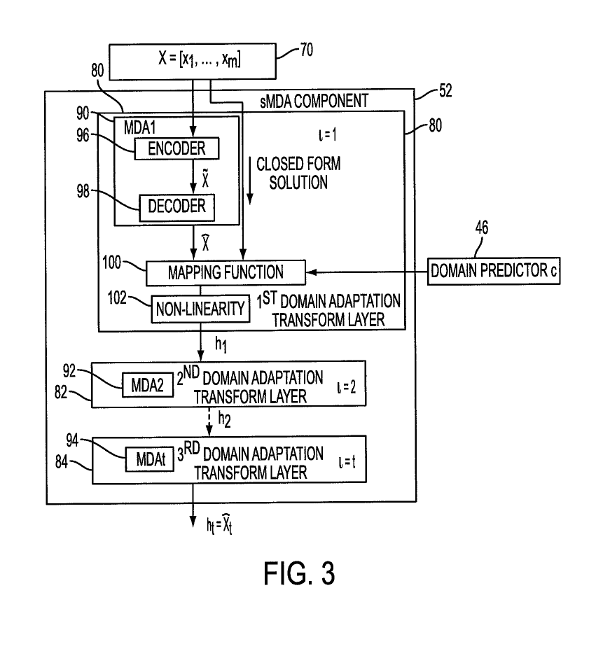

The mapping component 52 learns a mapping (a transformation) 72, denoted W, for converting both source and target samples (such as samples 34, 36, 38, or a different set of source or target samples) to domain-adapted samples (multidimensional vectorial representations) 40 in a new feature space in which domain predictions output by the domain predictor 46 are closer to the target domain, on average. An example mapping component 52 is illustrated in FIG. 3.

The classifier learning component 54 uses the adapted samples 40 to learn or update the classifier model 42 for predicting class labels for target samples 36, 38. The learned classifier model 42 may be output to the client computing device 24 or used by the system.

In the latter case, the classifier component 56 uses the classifier model 42 to predict a classification value 44, such as a class label, or a distribution over a set of labels for a target sample 38.

The labeling component 58 applies a class label 74 to the target sample 38, based on the classification value 44 of the classifier model 42. The class with the highest probability on the model 42 can be assigned as the class label 74 of the target sample, or a set of n-best class labels may be applied.

The processing component 60 may implement a computer implemented process, based on the applied class label 74.

The output component 62 outputs information 48, such as the trained classifier model 42, computed class label(s) 74 for the target sample(s), and/or other information based thereon.

The memory 12 may represent any type of non-transitory computer readable medium such as random access memory (RAM), read only memory (ROM), magnetic disk or tape, optical disk, flash memory, holographic memory or combination thereof. In one embodiment, the memory 12 comprises a combination of random access memory and read only memory.

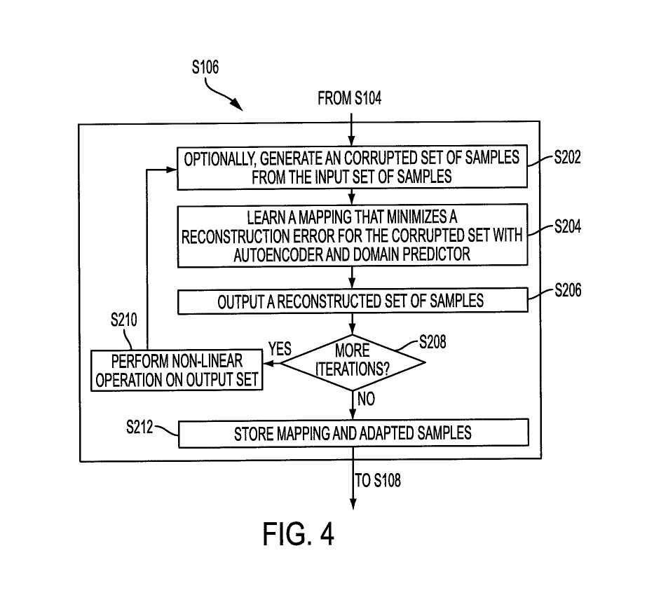

The digital processor 16 can be variously embodied, such as by a single-core processor, a dual-core processor (or more generally by a multiple-core processor), a digital processor and cooperating math coprocessor, a digital controller, or the like. The exemplary digital processor 16, in addition to controlling the operation of the computer system 18, executes the instructions 14 stored in memory 12 for performing the method outlined in FIGS. 2 and 4.

The customer devices may be similarly configured to the computer 18, with memory and a processor in communication with the memory, configured for interacting with the system 10.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, flash memory, holographic memory, or the like, and is also intended to encompass so-called “firmware” that is software stored on a ROM or the like. Such software may be organized in various ways, and may include software components organized as libraries, Internet-based programs stored on a remote server, source code, interpretive code, object code, directly executable code, and so forth. It is contemplated that the software may invoke system-level code or calls to other software residing on a server or other location to perform certain functions.

FIG. 2 illustrates a method for domain adaptation which can be performed with the system of FIG. 1. The method begins at S100.

At S102, a training collection 32 containing sets of multidimensional source and target samples in an input feature space, is received. The source samples are each labeled with a respective class. The samples 34, 36 may be stored in memory 12 during processing.

At S104, the samples 34, 36 are aggregated using the aggregating component 50.

At S106, a domain predictor is used based in the input training samples and the domains from which they were drawn.

At S108, the aggregated source and target samples are used to learn a mapping 72 for mapping samples to a new feature space, by the mapping component 52, using inputs from the domain predictor 46 to bias the adapted samples towards the target (or source) domain. The mapping 72 may be stored in memory 12.

At S110, a classifier model 42 may be learned or updated using adapted source samples and their class labels, e.g., a model for each of the classes, by the classifier component 56.

At S112, classification values 44 may be assigned to one or more target samples 38 (or target samples 36 from the training set) by using the learned classifier model 42 to predict classification values for the source samples projected into the new feature space with the learned mapping 72.

At S114, a class label 74 may be assigned to the target sample 36, 38 by the labeling component 58, based on the output classification value 44.

At S116, a task may be performed, based on the class prediction 44, or assigned class label(s) 74, by the sample processing component 60.

At S118, information 48 is output from the system, by the output component 62, such as the mapping 72 learned at S108, the classifier model 42 learned at S110, the class labels assigned at S112 or S114, and/or the output of the task performed at S116.

The method ends at S120.

As illustrated in FIG. 4, the learning of the mapping 72 (S106) may include, for at least one, or at least a plurality of iterations, optionally, generating a corrupted set of representations from the input set of representations (S202), which is not needed when the closed form described below is used, learning a mapping that minimizes a reconstruction error for the corrupted set (S204) when a reconstructed set is generated by applying the transformation to the corrupted set, and outputting an adapted (i.e., reconstructed) set of representations (S206). If at S208, more iterations are to be performed, the input set for a subsequent iteration is based on an adapted set of representations generated in a first of the iterations, optionally, after performing a non-linear operation (S210). Otherwise, the method proceeds from S208 to S212, where the learned mapping 72 and mapped samples are stored.

The method illustrated in FIGS. 2 and 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 18, (for example, an internal hard drive of RAM), or may be separate (for example, an external hard drive operatively connected with the computer 18), or may be separate and accessed via a digital data network such as a local area network (LAN) or the Internet (for example, as a redundant array of inexpensive or independent disks (RAID) or other network server storage that is indirectly accessed by the computer 18, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 2 and/or 4, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

Denoising autoencoders and their stacked marginalization version (mSDA) are an effective method for unsupervised domain adaptation. By jointly denoising the source and target data, they can generate a common representation. Adding a domain prediction component to (mSDA) facilitates learning of domain invariant features, which can be achieved in an unsupervised way. However, instead of extracting domain invariant features, the exemplary method seeks to transform/denoise source samples in such a way that the feature distributions get closer to the target ones.

In the following, a basic sMDA method is described and then a method for extending sMDA with domain prediction regularization is described. The approach is formalized as a convex optimization problem yielding a closed form solution in the unsupervised case (no target sample class labels). This allows a considerable reduction in training time over existing approaches, while giving comparable or better performance results, as illustrated in the Examples.

Description of mSDA

Denoising autoencoders (DA) are one-layer neural networks that are optimized to reconstruct input data from partial and random corruption. These denoisers can be stacked into deep learning architectures in which each subsequent layer operates on the output of the previous layer.

The exemplary mapping component 52 used herein can be based on the stacked marginalized Denoising Autoencoder (sMDA) described in Chen 2012, which will now be briefly described. The sMDA is a version of the multi-layer neural network trained to reconstruct input data from partial random corruption (see, P. Vincent, et al., “Extracting and composing robust features with denoising autoencoders,” ICML pp. 1096-1103, 2008). In the method of Chen, the random corruption is marginalized out, yielding the optimal reconstruction weights in the closed-form and avoids the need for backpropagation in tuning. Features learned with this approach lead to classification accuracy comparable with sDAs. See Z. Xu, et al., “From sBoW to dCoT marginalized encoders for text representation,” CIKM, pp. 1879-1884, 2012. The software code for the sMDA of Chen is available on the author's webpage at http://www.cse.wustl.edu/˜mchen/.

As illustrated in FIG. 3, the sMDA 52 is a stack of t domain adaptation transform layers 80, 82 84, etc. (although a single layer may be used in one embodiment). Each layer includes a linear denoising autoencoder (MDA) 90, 92, 94, etc. Each autoencoder includes an encoder 96 and a decoder 98 (only the components of the first layer are shown for ease of illustration). Each encoder 96 takes as input a set X of representations and corrupts them by adding random noise to give a corrupted set of representations \tilde{X}. The decoder 98 then attempts to reconstruct the input representations producing, in the process, a reconstructed set of representations \hat{X}. This corruption and reconstruction can be replaced by a closed form solution, as described below.

In the present method, for the first layer 80, the input X to the autoencoder 70 includes a set of nₜ target samples 36, denoted X_{T} [x₁^{T}, . . . , xₙ_{ₜ}^{T}] and nₛ source samples 34, for each of at least one source domain, denoted by Xₛ=[x₁^{S}, . . . , xₙ_{ₛ}^{S}]. Thus the input set input to the first layer is X=[X_{T},X_{S}]=[x₁^{T}, . . . , xₙ_{ₜ}^{T}, x₁^{S}, . . . , xₙ_{ₛ}^{S}], i.e., a concatenation of the source and target samples in the input feature space, which for convenience can be expressed as X=[x₁, . . . , xₙ], where n=nₛ+nₜ and each xᵢ is drawn from one of the sets X_{T} and X_{S} and xᵢεR^{d}. The encoder 96 corrupts the input set X by random feature removal with a dropout probability p, where 0<p<1. The corrupted inputs are denoted by \tilde{X}ₘ=[\tilde{x}_{1,m}, . . . , \tilde{x}_{n,m}]. The corruption is performed M times giving a matrix containing M corrupted sets of samples, denoted \tilde{X}=[\tilde{X}_{T}\tilde{X}ₛ]=[\tilde{X}₁, . . . , \tilde{X}_{M}].

For example, if p is 0.1, for each feature in the vector there is a 10% probability that its value is set to 0 in the corruption. p may be, for example, from 0.05 to 0.95. Suitable values of p may be feature-dependent. For example, p=0.5 may be used as a default value in the case of features obtained from a neural network, while for BOV, a default value of p=0.1 may be used. A grid search may be performed, changing the value of p in increments of, for example, 0.05, to identify a suitable value of p.

The decoder 98 reconstructs the sample inputs with a linear mapping W: R^{d}→R^{d} that minimizes the squared reconstruction loss:

$$L ( W ) = \frac{1}{v} {\sum }_{m = 1}^{M} {\sum }_{i = 1}^{n} {‖ {x}_{i} - {\tilde{x}}_{i , m} W ‖}^{2} \qquad ( 1 )$$

where ∥xᵢ−\tilde{x}_{i,m}W∥ is the norm of xᵢ−\tilde{x}_{i,m}W,

ν represents the number of corrupted samples generated, i.e., ν=nM, and

\tilde{x}_{i,m} represents the mth corrupted version of the original input xᵢ.

In one embodiment, a constant feature can be added to the input, xᵢ=[xᵢ; 1], and an appropriate bias b can be incorporated within the mapping W=[W; b] which is never corrupted. In practice addition of a bias feature b was found not to improve results in the domain regularized formulation of mSDA.

The solution of Eqn. (1) can be expressed as the closed-form solution from ordinary least squares:

W=Q⁻¹P, (2)

where Q=\tilde{X}\tilde{X}^{T} and P=X\tilde{X}^{T}, and T is the transpose.

The solution of W depends on the corrupted sample inputs \tilde{x}_{i,j}. In practice, to compute W, iterative optimization of the loss (1), may be performed (e.g., using Stochastic Gradient descent) with a set of corrupted data or without explicit corruption of the data by marginalizing out directly the noise as described in Chen 2012. Chen 2012 has shown that by the weak law of large numbers, the matrices P and Q converge to their expected values [symbol] [P] and [symbol] [Q] as more copies of the corrupted data are created (letting M→∞). In the limit, the corresponding mapping for W can be expressed in closed form as:

W= [symbol] [Q]⁻¹ [symbol] [P], (3)

where the expectation of Q for a given entry in matrix [symbol] [Q],

denoted

$$( {𝔼 [ Q ]}_{i , j} ) = [ \begin{matrix}{S}_{ij} {q}_{i} {q}_{j} , if i \neq j , \\ {S}_{ij} {q}_{i} , if i = j ,\end{matrix} ]$$

and the expectation of P for a given entry in matrix [symbol] [P], denoted [symbol] [P]_{i,j}=Sᵢⱼqⱼ,

where i≠j indicates those values that are not on the diagonal of the matrix [symbol] [Q], and i=j those values that are on the diagonal of the matrix,

q=[1−p₁, . . . , 1−p_{w}]εR^{d}, where each element qᵢ represents the probability of a feature i surviving the corruption, and qᵢqⱼ represents the probability of features i and j both surviving the corruption=(1−p)²;

p is feature corruption probability (which can be the same for all features of the feature vector, or different);

d is the feature dimensionality (number of features in each xᵢ),

S=XX^{T} is the covariance matrix of the uncorrupted data X, and

Sᵢⱼ is an element of matrix S.

With the help of these expectation matrices, the reconstructive mapping W can be computed directly in closed-form using Eqn. (3). This closed-form denoising layer (optionally, with a unique noise p for each feature) is referred to herein as a marginalized Denoising Autoencoder (MDA). It can be used to provide a unique and optimal solution which can be computed in closed form and which also eliminates the need for using back-propagation.

As illustrated in FIG. 3, a deep architecture 52 can be created by stacking together several such MDA layers where the representations output by the (l−1)^{th} denoising layer are fed as the input to the l^{th} layer. The outputs (reconstructed inputs \tilde{x}_{i,j} transformed with a mapping function 100 (which in the present method incorporates matrix W and the domain predictor c) serve as the inputs X for the next layer (optionally after a non-linear operation). The number t of MDA layers 80, 82, 84 may be, for example, at least 1, or at least 2, or at least 3, or at least 4, and may be up to 100, or up to 20, or up to 10, or 5 or 6.

In order to extend the mapping beyond a linear transformation, between layers, a non-linearity 102 may be applied, such as applying, on each output, either tangent-hyperbolic nonlinearities:

hₗ=tan h(W^{l}hₗ₋₁) (4)

where h₀=X denotes the input,

or, alternatively, rectified linear units (RELU):

hₗ=max(W^{l}hₗ₋₁,0) (setting values less than 0 to 0) (5)

Each transformation W^{l} is learnt to reconstruct the previous layer's output hₗ from its corrupted equivalent. The final output hₜ, corresponding to the reconstruction of input hₜ₋₁ with matrix W^{t} is denoted \hat{X}ₜ.

An advantage of sMDA is that the loss function does not require class labels and hence unlabeled target data 36 can be employed for unsupervised domain adaptation.

In the exemplary embodiment, the noise level for a given feature is the same for target and source samples. In another embodiment, different feature corruption probabilities pₜ and pₛ, respectively, can be considered for target and source. Then, the expected value [symbol] Q=[\tilde{X}\tilde{X}^{T}] depends on whether \tilde{x}ᵢ is sampled from X_{T} or X_{S}. Given nₜ, the number of target samples and nₛ the number of source samples, the fractions of source samples and of target samples αₜ and αₛ are:

$${α}_{t} = \frac{{n}_{t}}{{n}_{t} + {n}_{s}} and {α}_{s} = \frac{{n}_{s}}{{n}_{t} + {n}_{s}} \qquad ( 6 )$$

Eqn. (6) can be generalized for the two feature corruption vectors qₜ=[1−pₜ, . . . , 1−pₜ, 1]εR^{d+1} and qₛ=[1−pₛ, . . . , 1−pₛ, 1]εR^{d+1}, as follows:

$${𝔼 [ Q ]}_{i , j} = \{ \begin{matrix}{S}_{ij} ( {α}_{t} {q}_{ti} {q}_{tj} + {α}_{s} {q}_{si} {q}_{sj} ) , if i \neq j , \\ {S}_{ij} ( {α}_{t} {q}_{ti} + {α}_{s} {q}_{si} ) , if i = j\end{matrix} , \qquad ( 7 )$$

and the expectation of P becomes

[symbol]

[P]_{i,j}=Sᵢⱼ(αₜqₜᵢ+αₛqₛⱼ) (8)

In another embodiment, the p values of U.S. application Ser. No. 15/013,273 can be used. The Ser. No. 15/013,273 application describes an extension of stacked marginalized denoising autoencoders (sMDA) by introducing a multi-noise marginalization for the sMDA.

In practice, however, using the same p values for all samples appears to work well.

Extending sMDA Model with Domain Prediction Regularization

An sMDA model 52, as described above, can be extended with domain prediction regularization for the domain adaptation task. The system may have access to the following:

Xₛ, the source sample collection 34, Xₛε [symbol] ⁿ^{ₛ}^{×d}, where nₛ is the number of source samples and d is the number of features;

Yₛ, a set of source sample class labels 35;

Xₜ, the target sample collection, Xₜε [symbol] ⁿ^{ₜ}^{×d}; where nₜ is the number of target samples 36 (labeled and/or unlabeled);

Yₜ, a set of corresponding target sample class labels 37 (optional); and

X denotes the concatenation of source and target samples,

X=[Xₛ; Xₜ]

The regularization employed relies on the domain predictor 46 (a classifier c) which is trained to predict the domain from which a sample xᵢ is drawn.

In the unsupervised domain adaptation, the aim is to transform source data Xₛ to make them indistinguishable from the target data Xₜ. In the case of text documents, the dropout technique used in sMDA can be used to corrupt and then reconstruct source documents in such a way that they look more like the target documents.

The domain predictor c 46 may be a linear classifier which is trained to predict −1 for source samples and +1 for target ones. The denoising/reconstruction of the source samples to make them look more like target samples can be formalized as follows:

$$L ( W ) = \frac{1}{n} {\sum }_{i = 1}^{n} ( {‖ {x}_{i} - {\tilde{x}}_{i} W ‖}^{2} + λ [ 1 - {\tilde{x}}_{l} Wc ] ) \qquad ( 9 )$$

where n is the number of source and target samples,
xᵢ represents a sample drawn from the set X,
\tilde{x}ᵢW represents a reconstructed sample,
\tilde{x}ᵢWc represents the domain classifier prediction for the reconstructed sample \tilde{x}ᵢW,
λ=is a fixed weight, which controls the impact of the domain classifier prediction. e.g., λ has a value of from 0.001 to 100, or at least 0.1 or up to 10.

In this model, the reconstruction loss for matrix W depends on two terms. The first term ∥x₁−\tilde{x}ᵢW∥² represents the denoising loss of the samples, as in sMDA. Minimizing the second term [1−\tilde{x}ᵢWc] forces all classifier predictions (for both source and target samples) to be closer to 1, the target domain indicator.

### Domain Predictor (S106)

First, the case of one single source domain will be considered. Let D be a (nₛ+nₜ)×1 binary vector indicating the domain for each sample in X (e.g., −1 for the source and +1 for the target domain). Then, the domain predictor c 46 can be a ridge classifier of dimensionality d×1, which can be learned as a standard linear predictor by minimizing a loss function, over the set X of source and target training samples, such as the following ridge loss:

[symbol]

(c,a)=∥D−Xc∥²+α∥c∥². (10)
where α is a regularization term weight.

α is generally non-zero and may have a value of 0.01 to 1000, such as at least 0.1, or up to 300. A suitable value of α can be established through cross validation experiments. In one embodiment it is about 100.

The linear classifier makes it easier to generate a closed form, although non-linear classifiers are also contemplated.

This can be generalized to multiple domains where D becomes a matrix indicating for each sample, its domain. For example, each row indicates, for a given one of the domains, whether each sample is from that domain or not (i.e., each row can be a binary vector). The dimension of such a matrix is then n×s, where s is the number of source domains. c is then a d×s matrix, where each column cᵢ serves as a linear regressor for predicting the source dataset Sᵢ.

### Generalized Model (Unsupervised Setting)

In this setting, it is assumed that there are no class labels Yₜ for the target samples.

Let Rₜ be a vector of size m (nₛ+nₜ), indicating, for each sample, a desired regularization objective. The following cases can be considered:

1. Rₜ=1 (all values of the vector are +1). In this case, all domain predictions should be towards the target (Target Regularized mSDA).

2. Rₜ=D. All domain predictions should keep distinguishing source and target domains.

3. Rₜ=−1 (all values of the vector are −1). In this case, all domain predictions should be towards the source domains.

4. Rₜ=[0, 1] (all values of the vector are 0 or 1, where 0 is used for the source data and 1 for the target data, or vice versa).

In the exemplary embodiment, the learning of the mapping W is guided in such a way that the reconstructed data points Wxᵢ go towards the target side, i.e., xᵢWc=1 for the source (and optionally also the target) samples.

Let X̅ be an M-times replication (concatenation) of the original data X and \tilde{X} be the matrix of the M different corrupted samples. R̅ₜ is the M-times replication (concatenation) of Rₜ. The loss can then be defined as:

L(W,c)=∥(X̅−\tilde{X}W∥²−λ∥R̅ₜ−\tilde{X}Wc∥² (11)

In the exemplary Target Regularized mSDA embodiment, Rₜ=1, i.e., a vector of 1's, or Rₜ=[0; 1], \tilde{X}Wc is the domain classifier prediction for the reconstructed samples forced to be close to 1, the target domain indicator, and λ>0.

The optimal W is the one which minimizes the loss in expectation:

minE[L(W,c)]ₚ (12)

where p is the random feature removal (dropout) distribution as described above for the conventional mSDA method. The optimal value of matrix W which minimizes this loss can be shown to be the solution of the following linear equation (see below for further details):

(\tilde{X}^{T}X̅−λ\tilde{X}^{T}Rₜc^{T})(I−Δcc^{T})⁻¹=\tilde{X}^{T}\tilde{X}W (13)

where I is the identity matrix; and
parameter A controls the effect of the target regularization in the MDA and the regularization on c is controlled by parameter α.

This approach preserves the good properties of MDA, i.e., the model is unsupervised and can be computed in closed form. In addition, several layers can be stacked together and non-linearities (e.g., using Eqn. (4) or (5)) added between layers, as for the conventional mSDA method.

The expectations of the terms in Eqn (13) can be computed in closed form, using P and Q, as in the baseline mSDA:

E[\tilde{X}^{T}\tilde{X}]=Q (14)

E[\tilde{X}^{T}\tilde{X}]=P (15)

E[\tilde{X}^{T}Rₜc^{T}]=(1−p)X^{T}Rₜc^{T} (16)

E[(\tilde{X}^{T}X̅−λ\tilde{X}^{T}Rₜc^{T})(I+λcc^{T})⁻¹]

=(P+λ(1−p)X^{t}Rₜc^{T})(I+λcc^{T})⁻¹ (17)

where Q and P are as defined above.

The mapping W which minimizes the expectation of

$$\frac{1}{M} L ( W )$$

is then the solution of the following linear equation 100:

(P+Δ(1−p)X̅^{T}Rₜc^{T})(1+Δcc^{T})⁻¹=QW. (18)

i.e., Q⁻¹(P^{T}−λ(1−p)X̅^{T}1c^{T})(I−Δcc^{T})⁻¹=W in the Target Regularized mSDA case where Rₜ is a vector of 1's, and the values of matrices P and Q computed as described above:

$${Q}_{i , j} = [ \begin{matrix}{S}_{ij} {q}_{i} {q}_{j} , if i \neq j , \\ {S}_{ij} {q}_{i} , if i = j ,\end{matrix} ] , \\ {P}_{i , j} = {S}_{ij} {q}_{j} ,$$

where q=[1−p₁, . . . , 1−p_{d}]εR^{d}, where p₁ to p_{d} can be the same or different, d being the number of dimensions, which can be extended by 1 if a bias is employed, and
S=XX^{T} is the covariance matrix of the uncorrupted data X.

This model formulation is quite generic and can be used to implement different objectives:

1. Using λ>0 and Rₜ=D, the model aims at promoting domain invariant features.

2. Using λ<0 and Rₜ=+1. In this case, the model implements the target regularization, and favors target specific features.

3. Using λ>0 and Rₜ=−1. In this case, the model penalizes source specific features (the desired result in the exemplary embodiment).

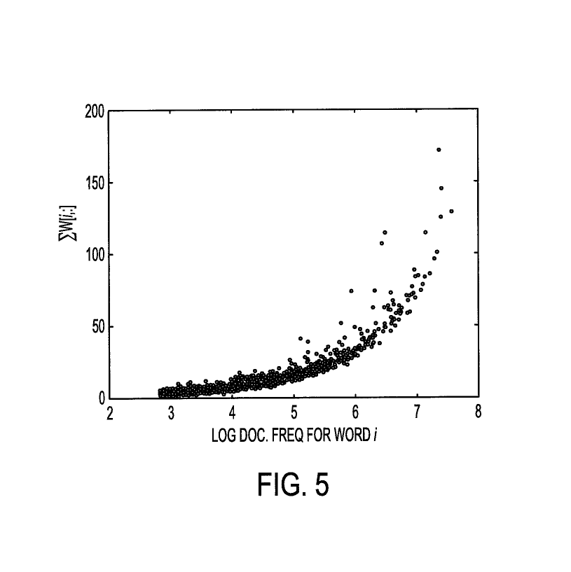

The improvements of the method can be explained as follows. mSDA serves, in part, as a document expansion on text documents, by adding new words with a very small frequency, sometimes adding words with a small negative weight (a document is transformed by xW′). The total mass of words transformed into word i is given by the quantity ΣW[i,:], referred to as the expansion weight. FIG. 5 shows the relation between the word log document frequency and the expansion weight. This clearly shows that mSDA are biased toward common words (despite the use of a tf-idf weighting scheme). This is not necessarily bad as it favors frequent words in both domains (the union of source and target), effectively capturing some domain invariant features. Since the classification task is performed with samples drawn from the target distribution, the objective is to match the target feature distribution. The aim is therefore to project the samples to be as close as possible to the target domain distribution, and thus domain invariant features alone are not sufficient.

### Semi-Supervised Model

The generalized model described above addresses the unsupervised setting. In the semi-supervised setting, when at least some target samples are class labeled, the model can be extended by including a term of the categorization loss on the target examples. To learn a ridge classifier on the labeled ones of the target samples Xₜ (which may be denoted Xₜ^{l}) that are labeled with labels Yₜ, then a model of the general form:

L(W,z)=∥X̅−\tilde{X}W∥²+λ∥1−\tilde{X}Wc∥²+γ∥Yₜ−Xₜ^{l}Wz∥² (19)

can be used, where z is a classifier for reconstructed target samples in the adapted feature space and γ is a tradeoff parameter. Using marginalization, the optimal solution to (19) would jointly minimize the denoising transformation W and the square loss for the target classifier z. Unlike in the unsupervised setting described above, the solution does not have a closed form. Instead, it can be written as Sylvester equation (an equation of the general form A₁x+xA₂=A₃, where A₁, A₂, and A₃ are the given matrices and x is a possible matrix that obeys the equation). This type of equation has a unique solution and an algorithm converging to this solution. See, Valeria Simoncini, “Computational methods for linear matrix equations,” SIAM Review, 2013.

Loss (13) is a class of optimization functions which depend non-linearly on two variables, W and z. Moreover, it is convex in W for a fixed z, and convex in z for a fixed W. In the simple case of α=0, minimizing (19) in both W and z gives the following equations to solve:

$$\begin{matrix}\frac{\partial L ( W , z )}{\partial W} = - {\tilde{X}}^{T} \overline{X} + \tilde{X} {\tilde{X}}^{T} W + {γX}_{t}^{l} {Y}_{t} z - {γX}_{t}^{l} {X}_{t}^{{l}^{T}} {Wzz}^{T} & ( 20 ) \\ \frac{\partial L ( W , z )}{\partial W} = {X}_{l} W ( {Y}_{t} - {X}_{t}^{l} Wz ) = 0. & ( 21 )\end{matrix}$$

Alternatively, both labeled source and labeled target examples can be used to learn the classifier z. In this case, Xₜ^{l} is replaced with X^{l}=[Xₛ;Xₜ^{l}] and Yₜ is replaced with Y^{l}=[Yₛ; Yₜ^{l}] in Eqn. (20) and (21).

Sylvester Equation

Due to the disjoint convexity, alternating the solutions for (20) and (21) will converge to the optimal solution. While (20) can be solved in the closed form, (21) requires another approach. It can be reduced to solving equation A₁W+WA₂=A₃ for known matrices A₁, A₂ and A₃. This Sylvester equation has a unique solution for W when there are no common eigenvalues of A₁ and −A₂. A suitable algorithm for the numerical solution of the Sylvester equation is the Bartels-Stewart algorithm, which entails transforming A₁ and A₂ into Schur form by a QR algorithm, and then solving the resulting triangular system via back-substitution. This algorithm has the O(w³) computational cost, and can be implemented in a matrix programming library such as LAPACK, e.g., in Matlab.

### Derivation of the Model

Eqn (11) above can be considered as two terms F and G.

$$L ( W , c ) = \underbrace{{‖ \overline{X} - \tilde{X} W ‖}^{2}}_{F} - λ \underbrace{{‖ {R}_{t} - \tilde{X} Wc ‖}^{2}}_{G} \qquad ( 11 )$$

The F term can be expanded, then derivatives computed (Expectations of derivatives are the derivatives of expectations). Tr represents the trace of a matrix (sum of its diagonal elements).

F=Tr[(X̅−\tilde{X}W)^{T}(X̅−\tilde{X}W)] (22)

F=Tr[X̅^{T}X̅]−Tr[X̅^{T}\tilde{X}W]−Tr[W^{T}\tilde{X}^{T}X̅]+Tr[W^{T}\tilde{X}^{T}\tilde{X}W] (23)

F=Tr[X̅^{T}X̅]−2Tr[X̅^{T}\tilde{X}W]+Tr[W^{T}\tilde{X}^{T}\tilde{X}W] (24)

Now deriving F:

$$\begin{matrix}\frac{\partial Tr [ {\overline{X}}^{T} \tilde{X} W ]}{\partial W} = {\tilde{X}}^{T} \overline{X} & ( 25 ) \\ \frac{\partial Tr [ {W}^{T} {\tilde{X}}^{T} \tilde{X} W ]}{\partial W} = 2 {\tilde{X}}^{T} \tilde{X} W & ( 26 )\end{matrix}$$

Going back to G,

G=Tr[(Rₜ−\tilde{X}Wc)^{T}(Rₜ−\tilde{X}Wc)] (27)

G=Tr[(Rₜ^{T}−c^{T}W^{T}\tilde{X}^{T})(Rₜ−\tilde{X}Wc)] (28)

G=Tr[Rₜ^{T}Rₜ]−2Tr[Rₜ^{T}\tilde{X}Wc]+Tr[c^{T}W^{T}\tilde{X}^{T}\tilde{X}Wc] (29)

Now deriving G:

$$\begin{matrix}\frac{\partial Tr [ {R}_{t}^{T} \tilde{X} Wc ]}{\partial W} = {\tilde{X}}^{T} {R}_{t} {c}^{T} & ( 30 ) \\ \frac{\partial Tr [ {c}^{T} {WW}^{T} {\tilde{X}}^{T} \tilde{X} Wc ]}{\partial W} = 2 {\tilde{X}}^{T} \tilde{X} {Wcc}^{T} & ( 31 )\end{matrix}$$

The derivative of the Loss function is therefore:

$$\frac{L ( W , c )}{\partial W} = - 2 {\tilde{X}}^{T} \overline{X} + 2 {\tilde{X}}^{T} \tilde{X} W + 2 λ {\tilde{X}}^{T} {R}_{t} {c}^{T} - 2 λ {\tilde{X}}^{T} \tilde{X} {Wcc}^{T} \qquad ( 32 )$$

Thus, equating the derivative to zero yields:

\tilde{X}^{T}X̅−λ\tilde{X}^{T}Rₜc^{T}=\tilde{X}^{T}X̅W−λ\tilde{X}^{T}\tilde{X}Wcc^{T} (33)

=\tilde{X}^{T}\tilde{X}W(I−λcc^{T}) (34)

So if the matrix (I−λCC^{t}) is invertible, this yields:

\tilde{X}^{T}X̅−λ\tilde{X}^{T}Rₜc^{T})(I−λcc^{T})⁻¹=\tilde{X}^{T}\tilde{X}W (35)

Then, the expectations of above matrix can be computed (as in mSDA) as shown above in Eqns (14)-(17).

### Classifier Learning (S110)

The classifier model 42 for predicting classification values 44 can be learned using labeled samples from the training set that have been domain adapted to the adapted feature space using the model 52.

The output of the iterative processing sequence is a stack of denoising autoencoders h₁, . . . , hₜ constructed for chosen feature corruption probabilities. This stack of domain adaptation transform layers h₁, . . . , hₜ is operative to transform the samples from the different domains to a common adapted feature space. Moreover, execution of the t=1, . . . , l iterations of the update operation has performed this transformation of the training samples to the common adapted feature space. Accordingly, the training samples transformed to the common adapted feature space are suitably used by the classifier learning component 54 to learn a classifier model 42 to label samples in the common adapted domain. The learning component 54 can employ substantially any architecture to generate the classifier 42 with that architecture. For example, in some embodiments, the learning component 54 employs a supervised learning method, such as a support vector machines (SVM) training architecture to generate the classifier 42 as a linear SVM classifier. In other embodiments, an unsupervised (e.g. clustering) learning technique is used to generate the classifier 42. For example, an unsupervised k-means clustering architecture can be used to generate the classifier 42. Semi-supervised learning techniques may also be used. In the case of unsupervised learning, the class labels are generally not known a priori (and in some cases even the number of classes is not known a priori). Accordingly, in embodiments employing unsupervised learning the classifier training may include manual review of and labeling of the resulting clusters. Other human feedback for the classifier training is also contemplated, such as providing initial conditions for initiating an iterative classifier learning process.

The exemplary classifier training uses class labels Yₛ (and Yₜ if available) in the case of supervised or semi-supervised learning.

To predict a class for a new sample 38, the new sample is mapped to the adapted feature space with the learned mapping W and the adapted representation classified with the trained classifier model 42. A prediction may be computed for each of a set of classed and the most probable class assigned to the sample.

### Source and Target Samples

The source and target samples 34, 36, 38 are multidimensional representations of objects, such as text documents or images, in the input feature space, and may be generated based on features extracted from the source/target objects. Each multidimensional feature representation includes d features (dimensions), where d may be at least 10, or at least 50, or at least 100, or at least 1000, or more.

In the case of images, the samples generated for each object can be any suitable high level statistical representation of the image, such as a multidimensional vector generated based on features extracted from the image. Fisher Kernel representations, Bag-of-Visual-Word representations, run length histograms, and representations generated with convolutional neural networks (CNNs) are exemplary of such high-level statistical representations which can be used herein as an image representation. These representations are based on the pixels of the image.

In the case of Fisher Kernel representations and Bag-of-Visual-Word representations, low level visual features, such as gradient (e.g., SIFT), shape, texture, or color features, or the like are extracted from patches of the image. The patches can be obtained by image segmentation, by applying specific interest point detectors, by considering a regular grid, or simply by the random sampling of image patches. In the exemplary embodiment, the patches are extracted on a regular grid, optionally at multiple scales, over the entire image, or at least a part or a majority of the image. Each patch includes a plurality of pixels and may include, for example, at least 4, or at least 16 or at least 64 or at least 100 pixels. The number of patches per image or region of an image is not limited but can be for example, at least 16 or at least 64 or at least 128. The extracted low level features (in the form of a local descriptor, such as a vector or histogram) from each patch can be concatenated and optionally reduced in dimensionality, to form a features vector which serves as the global image signature. In other approaches, the local descriptors of the patches of an image are assigned to clusters. For example, a visual vocabulary is previously obtained by clustering local descriptors extracted from training images, using for instance K-means clustering analysis. Each patch vector is then assigned to a nearest cluster and a histogram of the assignments can be generated. In other approaches, a probabilistic framework is employed. For example, it is assumed that there exists an underlying generative model, such as a Gaussian Mixture Model (GMM), from which all the local descriptors are emitted. The patches can thus be characterized by a vector of weights, one weight per parameter considered for each of the Gaussian functions forming the mixture model. In this case, the visual vocabulary can be estimated using the Expectation-Maximization (EM) algorithm. In either case, each visual word in the vocabulary corresponds to a grouping of typical low-level features. Given an image to be assigned a representation, each extracted local descriptor is assigned to its closest visual word in the previously trained vocabulary or to all visual words in a probabilistic manner in the case of a stochastic model. A histogram is computed by accumulating the occurrences of each visual word. The histogram can serve as the image representation or input to a generative model which outputs an image representation based thereon. See for example, U.S. Pub. Nos. 20080069456 and 20110091105 for a description of BOV representations, U.S. Pub. Nos. 20120076401 and 20120045134 for a description of Fisher Vector (FV) representations.

Various methods exist for generating representations based on neural networks. In this method, the sample to be represented (e.g., an image or a text document) is input to a sequence of convolutional layers and fully-connected layers. See, Krizhevsky, et al., “ImageNet classification with deep convolutional neural networks,” NIPS, pp. 1106-1114, 2012; Zeiler, et al., “Visualizing and understanding convolutional networks,” ECCV, pp. 818-833, 2014; Sermanet, et al., “OverFeat: Integrated recognition, localization and detection using convolutional networks,” ICLR, 2014; Simonyan, et al., “Very Deep Convolutional Networks for Large-Scale Image Recognition,” arxiv 1409.1556, 2014. Convolutional networks or “ConvNets” are trained in a supervised fashion on large amounts of labeled data. These models are feed-forward architectures involving multiple computational layers that alternate linear operations, such as convolutions or average-pooling, and non-linear operations, such as max-pooling and sigmoid activations. The image representation may be derived from the output of the final fully-connected layer, or from one of the intermediate layers. In some embodiments, the advantages of Fisher vectors and CNN's can be combined using a framework as described, for example, in U.S. application Ser. No. 14/793,434, filed Jul. 7, 2015, entitled EXTRACTING GRADIENT FEATURES FROM NEURAL NETWORKS, by Albert Gordo Soldevila, et al.

Run length histograms are described in U.S. Pub. No. 20100092084.

For generating representations of text documents, at least a portion of the words in the document are considered as the features and a histogram of word frequencies is computed. The histogram may consider the frequencies of each of a fixed word vocabulary (and/or short sequences of words), such as a limited dictionary of words/phrases which may exclude certain words commonly found in all documents (stop words). A transformation, such as a term frequency-inverse document frequency (TF-IDF) transformation, may be applied to the word frequencies to reduce the impact of words which commonly appear in the documents being represented. The word/phrase frequencies may be normalized, e.g., with L2 normalization. The result is in a vector of normalized frequencies (a document representation), where each element of the vector corresponds to a respective dimension in the multidimensional space.

The disclosures of all of these references are incorporated herein by reference in their entireties.

### Example Applications

There are numerous applications in which the system and method find application, such as in the classification of forms from different organizations, opinions, such as customer opinions of products and services (where classifiers/representations learned on one type of product or service can be adapted to a new product/service), customer inquiries, health care data, transportation-related images, such as images of vehicles, vehicle occupants, and number plates, and the like.

Without intending to limit the scope of the exemplary embodiment, the following examples illustrate application of the unsupervised model.

### Examples

Experiments were conducted on standard textual domain adaptation tasks using the Amazon review dataset (AMT) and 20newsgroup (Newsgroup) sets.

AMT: The Amazon text dataset consists of products reviews in different domains. Although a book review can be quite different to a kitchen item review, there are nevertheless some common features to assess whether the reviewers were satisfied with their purchases. A sub-part of this collection has been preprocessed by Blitzer, et al., “Domain Adaptation with Coupled Subspaces,” Proc. 14th Intl Conf. on Artificial Intelligence and Statistics (AISTATS), 2011. First, the task is to predict whether a customer review is positive or negative where a review with more than 3 stars is considered as positive and (strictly) less than 3 as negative. After preprocessing, documents are represented by a bag of unigrams and bigrams. For the present experiments, only the top 5,000 n-gram features were considered according to document frequency and the four domains used in most studies: kitchen, dvd, books and electronics.

20NG: The 20 Newsgroup dataset is a very popular dataset for text categorization (S. J. PAN, et al., “A survey on transfer learning,” IEEE Trans. on Knowledge and Data Engineering, 22(10):1345-1359, 2010, “Pan 2010”). It has around 20,000 documents with 20 classes. For standard text classification, only a subset of the available categories were used, namely (‘comp.sys.ibm.pc.hardware’, ‘comp.sys.mac.hardware’, ‘sci.med’, ‘rec.sport.baseball’, ‘rec.sporthockey’, ‘sci.space’). Rare words appearing less than 3 times were filtered out and, at most, 10,000 features were kept. As the 20 classes have a hierarchical structure, domain adaptation problems can be simulated by training only on some leaf categories and testing on their sibling categories. For example, a source category could be ‘science’ with ‘sci.crypt and ‘sci.electronic’ and the target equivalent of this category would be ‘sci.med’ and ‘sci.space’. Following the settings of Pan 2010, several transfer tasks were considered. Logistic Regression (LR) was used to classify the reviews.

The 5,000 most frequent features were used for each adaptation task with a tf-idf weighting. The mSDA feature corruption probability (dropout probability) p was fixed at 0.9. Cross validation on the reconstructed source dataset was used to choose the optimal parameters of αε[0.1,1,50,100,150,200,300] and λΣ[0.01,0.1,1,10].

TABLE 1 shows classification accuracy values for twelve adaptation tasks on the Amazon dataset. It compares 1-layered sMDA (baseline mSDA) to sMDA with the present target regularization and results of Ganin, et al. (Yaroslav Ganin, et al., “Unsupervised domain adaptation by backpropagation,” Proc. 32nd Intl Conf. on Machine Learning (ICML 2015), pp. 1180-1189, 2015, “Ganin 1”; Yaroslav Ganin, et al., “Domain-adversarial training of neural networks,” arXiv:1505.07818, 2015, “Ganin 2”). Ganin 1 used as input a mSDA with 5,000 features with the output of five layers being concatenated with the input, making a total of 30,000 input features for their neural network. Although Ganin 1 is different from the present MSDA baseline method because a) they use more features and b) they trained an SVM rather than Logistic Regression, similar results are obtained to the present MSDA baseline method.

TABLE 1
Accuracy values for mSDA Baseline, Target Regularized
mSDA and results reported by Ganin et al. on AMT

| | | | Target | | |
|---|---|---|---|---|---|
| | | mSDA | Regularized | mSDA | DA NN |
| Source | target | Baseline | mSDA | (Ganin 1) | (Ganin 2) |
| DVD | Books | 81.1 | 81.5 | 82.6 | 82.5 |
| DVD | Kitchen | 84.1 | 85.6 | 84.2 | 84.9 |
| DVD | Elec- | 76.0 | 81.3 | 73.9 | 80.9 |
| | tronics | | | | |
| Books | DVD | 82.7 | 81.9 | 83.0 | 82.9 |
| Books | Kitchen | 79.8 | 82.9 | 82.1 | 84.3 |
| Books | Elec- | 75.9 | 79.7 | 76.6 | 80.4 |
| | tronics | | | | |
| Kitchen | DVD | 78.5 | 78.8 | 78.8 | 78.9 |
| Kitchen | Books | 77.0 | 76.9 | 76.9 | 71.8 |
| Kitchen | Elec- | 87.2 | 87.5 | 86.1 | 85.6 |
| | tronics | | | | |
| Electronics | DVD | 78.5 | 78.4 | 77.0 | 78.1 |
| Electronics | Books | 73.3 | 75.1 | 76.2 | 77.4 |
| Electronics | Kitchen | 87.7 | 87.3 | 84.7 | 88.1 |

| | | | | |
|---|---|---|---|---|
| Average | 80.15 | 81.41 | 80.18 | 81.32 |

As can be seen from TABLE 1, the Target Regularized mSDA method yields an average accuracy of 81.41 where the Ganin 1's model reports a 81.31 average accuracy. It is to be noted that Ganin 1 used reverse cross-validation, which entails using self training on the unlabeled target example and calibrating parameters on a validation set from the source labeled data. This approach could be incorporated in the present method rather than cross-validating on the source. Overall, despite using only a single layer, the Target Regularized mSDA (without stacking mSDA layers) performs comparably with Ganin 2, where Domain-Adversarial. Training of Neural Networks (DA NN) was used instead of SVM, where results were obtained with a 5 layer sMDA and a 6 times larger feature set. As will be appreciated, the Target Regularized mSDA method has a much lower cost than DA NN, as it uses the closed form solution for the reconstruction and a simple LR on the reconstructed source data, instead of domain adversarial training of deep neural networks.

Classification accuracies for 20 newsgroup adaptation tasks showed that the Target Regularized mSDA method is always better than the baseline mSDA, with varying levels of improvement.

Performances of the Target Regularized mSDA method were evaluated for several values of α, λ for the twelve amazon adaptation tasks. By looking at each dataset, the best performance which could be obtained can be determined, and also the risk of using this approach. For all datasets except one dataset, the Target Regularized mSDA method can achieve comparable results or significant improvements, with appropriate selection of parameters, suggesting that the method is relatively robust to changes in parameter values.

### Qualitative Analysis

As discussed above, the total mass of words transformed into word i is given by the expansion weight ΣW[i,:]. The difference between the expansion weight from the baseline mSDA was compared to the Target Regularized mSDA. The words for which it changed the most for the task Kitchen to Books were, in ascending order of the difference: novel, world, life, people, about, author, characters, she, reading, book_is who, books, story, her, the_book, he, read, his, this_book, book. For the task DVD to Electronics, those words were: worked, to_use, speakers, i_have, work, mouse, bought, cable, works, quality, unit, ipod, price, _number_, sound, card, phone, use, product, my.

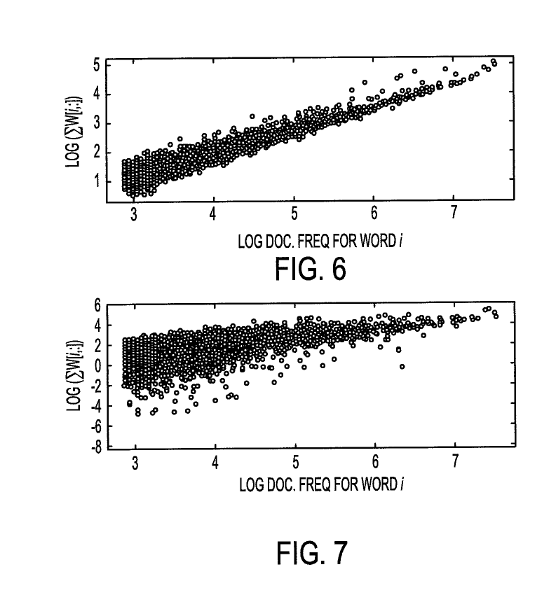

This shows that the Target Regularized mSDA model favors target specific words. FIGS. 6 and 7 show the relation between the expansion weight and the document frequency for the baseline mSDA and a target regularized mSDA, respectively. It can be seen that for target regularized mSDA, many words have a much smaller expansion weight.

The Target Regularized mSDA model favors features which are more likely to appear in target, while the Ganin approach seeks domain invariant features. Both approaches appear to penalize source specific features. A model which is designed to have this effect was tested using λ>0 and Rₜ=−1. In this case, the model penalizes source specific features and achieved similar performance (on the grid search) to the target regularization model.

Advantages of the present system and method include the following: (a) The mSDA combined with the target regularization is an unsupervised model, in the sense that it does not need to use the class annotations; (b) The solution to the mSDA learning can be computed in closed form, which may be faster that corrupting the samples and fine tuning a network with stochastic gradient descent; and (c) it does not require a learning technique such as gradient descent or back-propagation.

The exemplary model assumes a linear predictor to classify the domains. With some image features, this assumption may not hold. Kernelized feature spaces or other appropriate features spaces could be used. For textual data, this assumption seems more valid as new words, new expressions become much more frequent in a new domain of application and classifying a domain is easy and accurate (usually around 99% accuracy).

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for domain adaptation of samples comprising:
receiving training samples from a plurality of domains, the plurality of domains including at least one source domain and a target domain, each training sample including values for a set of features;
learning a domain predictor on at least some of the training samples from the plurality of domains and respective domain labels;
performing domain adaptation using marginalized denoising autoencoding operating on the training samples to generate at least one domain adaptation transform layer operative to transform the source and target training samples to a common adapted feature space, the domain adaptation employing the domain predictor to bias the domain adaptation of the training samples towards one of the plurality of domains; and
outputting at least one of:
the at least one domain adaptation transform layer, and
information generated therefrom.

2. The method of claim 1, wherein at least one of the learning a domain predictor and the performing domain adaptation is performed with a processor.

3. The method of claim 1, wherein the domain adaptation computes a mapping for mapping samples to the common adapted feature space as a function of a concatenation of the training samples, a selected dropout probability, and the domain predictor.

4. The method of claim 1, wherein the at least one domain adaptation transform layer computes a mapping W in closed form as a function of:
(P+λ(1−p)X̅^{T}Rₜc^{T})(I+λcc^{T})⁻¹Q⁻¹,
where
$${Q}_{i , j} = [ \begin{matrix}{S}_{ij} {q}_{i} {q}_{j} , if i \neq j , \\ {S}_{ij} {q}_{i} , if i = j ,\end{matrix} ] ,$$
P_{i,j}=Sᵢⱼqⱼ,
q=[1−p₁, . . . , 1−p_{d}]εR^{d}, where d is the number of dimensions i,
S=XX^{T} is the covariance matrix of the concatenation of the input training samples X,
pᵢ is a feature i corruption probability,
λ is a fixed weight,
X̅ is a replicated set of the input training samples;
Rₜ is a vector, indicating, for each training sample, a regularization objective; and
c is the domain predictor.

5. The method of claim 4, where Rₜ includes a value of 1 for training samples from the source domain.

6. The method of claim 4, wherein λ has a value of from 0.001 to 100.

7. The method of claim 1 wherein the domain predictor includes at least one vector of values, each vector including a value for each of the features in the set of features.

8. The method of claim 1, wherein the domain predictor is learned by minimizing a loss function, over the set X of source and target training samples, of the form: [symbol]
(c,α)=∥D−Xc∥²+α∥c∥²
where α is a regularization term weight;
D is a binary vector indicating the domain for each sample in X.

9. The method of claim 8, wherein α has a value of at least 0.01.

10. The method of claim 1, wherein the domain adaptation operates on the training samples with different feature corruption probabilities for at least one of:
different features of the set of features, and
different domains of the plurality of domains.

11. The method of claim 1, wherein the at least one domain adaptation transform layer comprises a plurality of domain adaptation transform layers stacked one over another.

12. The method of claim 11, wherein in at least one of the stacked domain adaptation transform layers, a non-linear function is applied to the transformed training samples.

13. The method of claim 1, further comprising performing supervised or semi-supervised learning on at least some of the training samples that have been transformed to the common adapted feature space, the training samples being labeled with labels from a set of class labels, to generate a classifier that outputs label predictions from the set of labels for the training samples and wherein the information comprises at least one of the trained classifier and a label prediction for a target sample generated with the trained classifier.

14. The method of claim 13, further comprising generating a label prediction for an input sample in the target domain represented by values for the set of features by applying the classifier to the input sample transformed to the common adapted feature space using the at least one domain adaptation transform layer.

15. The method of claim 1, wherein the training samples are representations of objects selected from text documents and images.

16. A non-transitory storage medium storing instructions which when executed by a computer, perform the method of claim 1.

17. A system comprising memory which stores instructions for performing the method of claim 1 and a processor in communication with the memory which execute the instructions.

18. A system comprising:
a domain predictor for predicting a domain of a plurality of domains for a sample, the sample including values for a set of features, the plurality of domains including at least one source domain and a target domain;
a mapping component which receives a set of training samples from the plurality of domains, each training sample including values for the set of features, the mapping component performing domain adaptation using marginalized denoising autoencoding on the set of training samples to generate at least one domain adaptation transform layer operative to transform the training samples to a common adapted feature space, the domain adaptation incorporating the domain predictor to bias the domain adaptation of the source domain training samples towards one of the plurality of domains; and
a processor which implements the mapping component.

19. The system of claim 18, further comprising:
a classifier learning component for learning a classifier with training samples transformed to the common adapted feature space, the training samples from each of the at least one source domain being labeled with class labels of a set of class labels.

20. A classification method comprising:
receiving an input sample from a source domain, the input sample including values for a set of features;
classifying the input sample with a classifier trained on a set of domain adapted training samples, the domain adapted training samples each including values for the set of features; the domain adapted training samples having been generated from a set of training samples, from a plurality of domains including a source domain and a target domain, that have been transformed to an adapted feature space using a marginalized denoising autoencoding layer incorporating a domain predictor, whereby the transformation of source domain target samples is biased towards the target domain such that the domain adapted source domain target samples are more likely to be predicted to be target domain samples by the domain predictor; and
outputting a label prediction for the input sample based on the classification.
